(19) United States
(12) Patent Application Publication
(10) Pub. No.: US 2008/0205977 A1
(43) Pub. Date: Aug. 28, 2008

(54) Operating Device For A Tool, For Example For Felling Trees As Well As An Auxiliary Tool Therefor

(76) Inventor: Fransiscus Adrianus Raaijmakers, Langenboom (NL)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 12/055,367

(22) Filed: Mar. 26, 2008

Related U.S. Application Data
(63) Continuation of application No. PCT/NL2005/000695, filed on Mar. 26, 2005.

(51) Int. Cl. F16D 1/00

(52) U.S. Cl. 403/322.1

(57) ABSTRACT

The invention relates to an operating device for a tool, comprising a frame to be coupled to the boom of an excavator or the like. at least one tool connected to the frame as well as adjusting means for positioning said at least one tool relative to the boom. The object of the invention is to provide a device of the kind referred to in the introduction, which enables a more versatile use and which, as a result of an improved maneuverability of the tool, is capable of carrying out operations also at places that were previously considered to be difficult to reach. According to the invention, the device is to that end characterized in that the adjusting means also comprise a ball and socket joint, which pivotally connects said at least one tool to the frame.

### CLAIM OF PRIORITY

This application claims priority under 35 USC § 119 and 365 of commonly owned PCT Application No. PCT/NL2005/000695 filed Mar. 26, 2005. This application designated the United States and was published in the English language on Mar. 29, 2007 as WO 2007/035083 which is incorporated in its entirety by reference.

### FIELD OF THE INVENTION

The invention relates to an operating device for a tool, comprising a frame to be coupled to the boom of an excavator or the like, at least one tool connected to the frame as well as adjusting means for positioning said at least one tool relative to the boom.

### DESCRIPTION OF RELATED ART

Such a device is known, for example from Dutch patent application No. 95/00343. and it can be used for lopping and/or felling trees. The known devices are arranged for felling trees in one go, for example by clamping a gripper element coupled to the boom around the trunk and cutting off the trunk near the ground by means of a tool, for example in the form of a sawing unit. The tree is then lowered to the ground in a controlled manner and either carried off or mechanically processed into manageable parts on site.

The extent to which the tool can be positioned with respect to the tree to be processed is quite limited with the device according to NL-95/00343, it fully depends on the maneuverability of the boom to which the tool is coupled. The generally robust construction of the boom as well as its dimensions and mass stand in the way of a flexible and precise positioning of the tool with respect to the tree that is to be felled, and consequently they are limiting factors as regards the usability of the devices that are currently known.

U.S. Pat. No. 5,101,872 and U.S. Pat. No. 6,408,906, U.S. Pat. No. 3,720,246 and US 2003/0,015,251 disclose operating devices of the same kind as the operating device referred to in the introduction, which devices comprise adjusting means for positioning the tool relative to the boom. However, also in the case of the devices disclosed in the aforesaid patent specifications the number of degrees of freedom for positioning the tool is limited.

### SUMMARY OF THE INVENTION

The object of the invention is to overcome the aforesaid drawback and to provide a device of the kind referred to in the introduction, which enables a more versatile use and which, as a result of an improved maneuverability of the tool, is capable of carrying out operations also at places that were previously considered to be difficult to reach. According to the invention, the device is to that end characterized in that the adjusting means also comprise a ball and socket joint, which pivotally connects said at least one tool to the frame.

This enables a more accurate positioning within a smaller positioning space of said at least one tool relative to the boom and consequently to the working position, for example a tree to be handled. Now said at least one tool can also carry out operations at locations which previously could not be reached by just maneuvering the boom.

Said more accurate positioning within a smaller positioning space of the at least one tool makes it possible to fell a tree in stages (“branch by branch”) rather than in one go when felling a tree by means of the device according to the invention. This makes it possible to use the device in residential areas, for example, where it is not possible to fell a tree in one go in connection with the presence of obstacles (houses, lamp posts, cars, etc).

The use of a ball and socket joint provides a certain degree of freedom, which makes it possible to position said at least one tool also at positions that are difficult to reach.

In a specific embodiment, by means of which an adequate control and positioning of the tool with respect to the working position (the tree, for example) can be obtained, the adjusting means engage the frame on the one hand and said at least one tool on the other hand.

In a functional embodiment, the adjusting means are embodied as hydraulically driven adjusting means, which can be driven more specifically by the hydraulic system of the excavator. This obviates the need for a separate driving line for driving the device according to the invention, which makes it possible to realize a simple and inexpensive construction of the device.

In another embodiment, the adjusting means are embodied as electromechanically driven adjusting means. The adjusting means may comprise at least one spindle drive, more in particular at least three spindle drives, in that case.

In another functional embodiment, on the other hand, the adjusting means comprise at least one, more in particular at least three, piston-cylinder combinations.

In a functional embodiment, said at least one tool is mounted on a supporting plate that is connected to the ball and socket joint, with the adjusting means engaging the supporting plate.

The supporting plate makes it possible on the one hand to accommodate several. different tools and on the other hand to make it easier to position said tools with respect to the boom.

In another functional embodiment, the adjusting means engage a guide element that is movable with respect to the frame. More specifically, the ball and socket joint can be connected to the frame by means of an arm, with the guide element being movably provided round the arm. This enables the guide element to orient itself upon adjustment of the ball and socket joint by means of the piston-cylinder combinations, so that jamming of the device is prevented.

In another functional embodiment, in which said at least one tool can be positioned with respect to the boom (and the tree to be felled), the ball and socket joint is connected to the frame by means of a telescopic extension element.

### BRIEF DESCRIPTION OF THE DRAWINGS

The particular features and advantages of the invention as well as other objects will become apparent from the following description taken in connection with the accompanying drawings in which:

FIG. 1 shows a prior art device, which is coupled to the boom of the excavator;

FIG. 2 shows a first embodiment of a device according to the invention;

FIG. 3 shows detail views of the embodiment of a device as shown in FIG. 2;

FIG. 4 shows a detail view of another part of the device according to the invention;

FIGS. 5a and 5b show detail views of another embodiment of a device according to the invention;

FIG. 6 shows yet another embodiment of a device according to the invention; and

FIG. 7 shows yet another embodiment of a device according to the invention.

### DETAILED DESCRIPTION OF THE PREFERRED EMBODIMENT

For a clear understanding, identical parts are indicated by the same numerals in the drawings. The invention will furthermore be explained by way of example on the basis of a device for felling trees. It will be understood, however, that the invention can also be used for other operations, such as digging trenches or mowing sloping surfaces (road banks, dikes) etc.

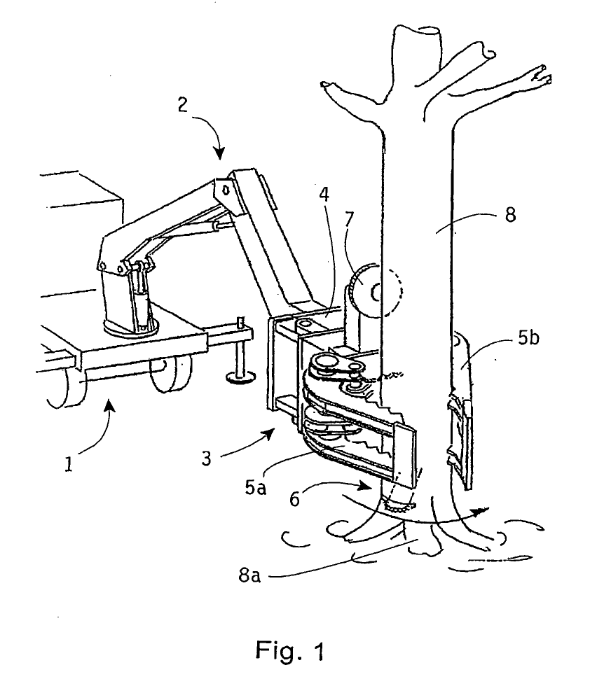

FIG. 1 shows a device according to the invention for lopping or felling trees. The device 3 is coupled to a boom 2 of an excavator 1 and is built up of a frame to which one or more felling tools 5a-5b, 6, 7 are mounted. The tool 5a-5b is made up of clamping jaws that can be positioned round the trunk of a tree 8. The tool 6 is a chainsaw unit, which can be driven through the trunk of the tree 8 by suitable driving means so as to cut it down. The tree 8 thus cut down, which is clamped between the clamping jaws 5a-5b, can be placed in a horizontal position by means of the boom 2 for further processing. The tool 7 is a chainsaw unit by means of which the roots 8a of the tree 8 can be cut.

A drawback of the device as shown in FIG. 1, which is disclosed in Dutch patent application NL-95/00343, is the limited extent to which the felling tool(s) can be positioned with respect to the tree 8 to be handled. More specifically, the positioning of the felling tools with respect to the tree 8 is fully dependent on the maneuverability of the boom 2 to which the device 3 is coupled. As FIG. 1 clearly shows, the boom 2 is of generally robust construction, and the dimensions and the mass thereof make it difficult to achieve a flexible and precise positioning of the device 3 and the felling tools 5a,5b,6,7 connected thereto with respect to the tree that is to be felled. The usability of the prior art device that is shown in FIG. 1 is limited, therefore.

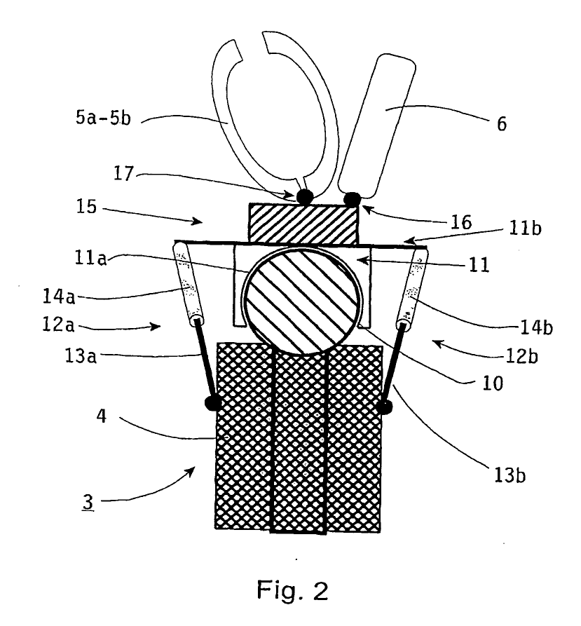

FIG. 2 shows a first embodiment of a device 3 according to the invention which enables a more versatile use and which is characterized by an improved maneuverability of the felling tools with respect to the tree 8 to be handled. According to the invention, the device 3 is provided with adjusting means 12a-12b for positioning the felling tool(s) with respect to the boom 2. The ball joint head 11 is provided with a socket 11a, in which the ball 10 can be received.

More in particular, the device 3 comprises a ball and socket joint 10,11 which pivotally connects the felling tools 5a,5b,6 to the frame 4 of the device 3. The ball and socket joint 10,11 provides an additional degree of freedom to be imposed on the various felling tools 5a,5b,6, making it possible to position said tools also at places round the tree 8 that could previously only be reached with (great) difficulty.

To enable a flexible, a three-dimensional positioning of the felling tools with respect to the frame 4 and the boom 2, the adjusting means are arranged in such a manner that they engage the frame 4 on the one hand and the felling tools on the other hand. The adjusting means may be embodied as hydraulically driven adjusting means, which can be driven in particular by the hydraulic system of the excavator 1. This obviates the need for a separate driving line for driving the device according to the invention, which leads to a simple and inexpensive construction.

In the hydraulic embodiment, the adjusting means comprise at least one piston-cylinder combination 13a,14a, but more specifically three piston-cylinder combinations 13a-14a, 13b-14b, 13c-14c (12a-12c), which latter piston-cylinder combination 13c-14c (12c) is not shown in FIG. 2. Using three different piston-cylinder combinations 12a-12c being symmetrically arranged around the ball and socket joint 10,11 and being connected to the frame 4 and to the felling tools 5a,5b,6, any desired position with respect to the boom 2 can be imposed upon the felling tools. Extension or retraction of the various piston-cylinder combinations 12a-12c results in movement of the ball joint head 11 over the ball 10 and thus in a required positioning of the felling tools with respect to the frame 4 and the boom 2.

The ball joint head 11 is furthermore provided with a supporting plate 11b, to which the various tools 5a,5b,6 can be mounted by means of connecting mechanisms that are known per se, whether or not via a drivable rotation unit 15, by means of which the tools can be rotated with respect to the frame 3. This provides an additional degree of movement, resulting in an enhanced usability of the device according to the invention.

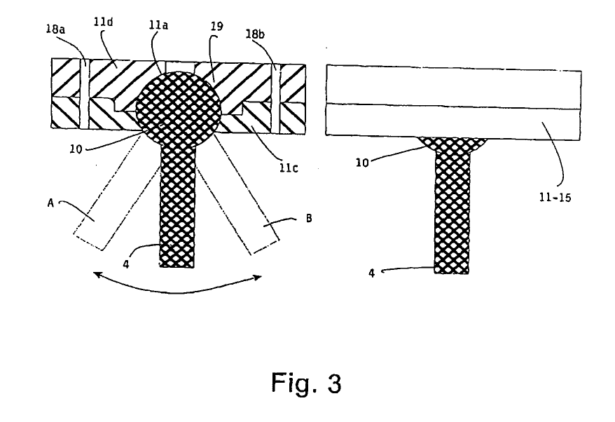

Preferably, the tools 5a,5b,6 are mounted to a supporting plate 15, on which the adjusting means 12a,12b,12c engage. In the embodiment that is shown in FIG. 3, the ball joint head 11 is divided into two plate members 11c,11d, which are provided with a socket-like recess 11a, in which the ball 10 of the ball and socket joint 10,11 can be received. The two plate members 11c,11d are fixed together by means of a bolt-nut connection extending through corresponding openings 18a,18b. The ball joint head 11 can be pivoted between two extreme positions A and B of the frame 4 with respect to the ball 10 by the adjusting means (not shown).

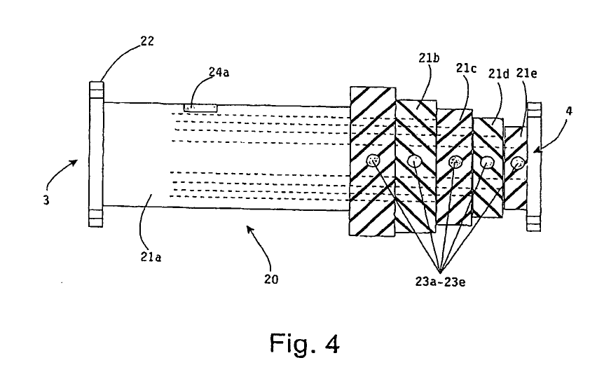

Another embodiment is shown in FIG. 4, which discloses a telescopic extension element 20 which can be connected to the boom 2 on the one hand (indicated at 3) and to the frame 4 on the other hand (as indicated at 4 in FIG. 4). The extension element 20 is preferably built up of several extension segments 21a,21e, which can telescope relative to each other and which can be retracted and extended by means of oil hydraulics. To that end a hydraulic medium under pressure (for example oil) is introduced into the extension cylinder segments 21a-21e via the opening 22. The extension element 20 may also be embodied as a multistage piston-cylinder combination. Numerals 23a-23e indicate filling nipples for supplying oil or grease for the purpose of lubricating the extension cylinder segments 21a-21e sliding or moving past one another.

The hydraulically driven telescopic extension element 20 makes it possible to effect an extension of the working range of the device according to the invention, which further enhances the usability of the device. The range of movement of the various extension cylinder segments 21a-21e is limited by various stops 24a-24e (only stop 24a is shown in FIG. 4), so as to limit the maximum amount of travel of the various extension cylinder segments.

In one embodiment, the maximum load the device is capable of handling is lower when the extension cylinder is in its fully extended position. The maximum load the device is capable of handling is higher when the extension cylinder is in its fully retracted position.

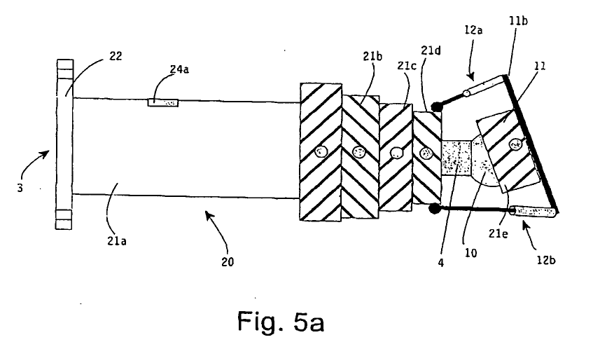

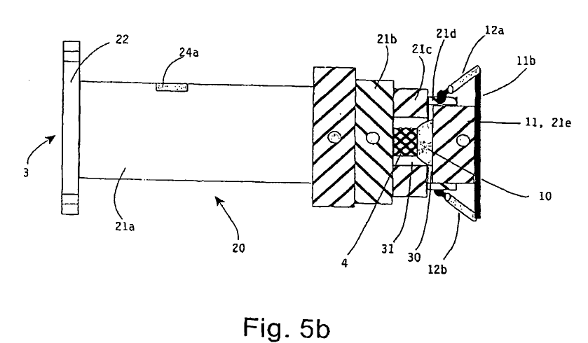

The detail views of FIGS. 5a and 5b show two operating situations of another embodiment of the device according to the invention. In this embodiment the ball and socket joint 10-11 forms part of the extension cylinder 20. The adjusting means 12a-12b-12c, etc. engage the ball joint head 11/the supporting plate 11b on the one hand and the extension segment 21d of the extension cylinder 20 on the other hand. This makes it possible to impose a random orientation with respect to the frame 3 on the ball joint head 11 and the supporting plate 11b (and the felling tools mounted thereon) via the adjusting means 12a-12b—etc. in the extended position of the extension cylinder 20.

Upon retraction of the extension the cylinder segment 21e in the direction of the extension cylinder segments 21b-21c-21d, the ball joint head 11 can be received in a recess that is present in the extension cylinder segment 21d. The recess is indicated at 30 in FIG. 5b. Since the ball joint head 11 can only be received in one orientation in the recess 30 of the extension cylinder segment 21d upon retraction of the extension cylinder 20, a functional locking or fixation of the ball and socket joint 10-11 is obtained. The ball and socket joint 10 and the frame element 4 are accommodated in a recess 31 formed in the extension cylinder segment 21c in that situation.

As a result of said locking or fixation of the ball and socket joint 10-11 in the fully retracted position that is shown in FIG. 5b, the device is very suitable for handling heavy masses which, for safety reasons, cannot be maneuvered by means of the ball and socket joint 10-11.

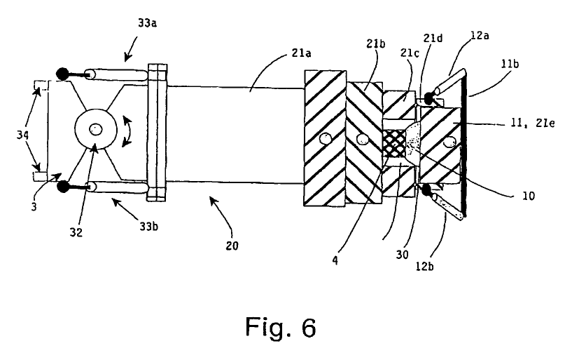

FIG. 6 shows yet another embodiment of a device according to the invention, in which the extension cylinder 20 is connected to the frame 3 by means of a hinge mechanism 32-33a-33b. The frame 3 can in turn be connected to the boom (not shown) of an excavator by connecting means 34 that are known per se. (Also refer to FIG. 1). Since the extension cylinder 20 can be pivoted with respect to the frame 3 and the boom of the excavator by additional adjusting means 33a-33b (also in this case embodied as hydraulic piston-cylinder combinations or electromagnetically driven spindles), an additional degree of movement of the device according to the invention is obtained.

In this way it is possible to maneuver the felling tools that are mounted on the supporting plate 11b to any desired position with respect to the frame 3 and the boom 2 of the excavator. Because of this feature the device according to the invention is more versatile than the devices that are known so far.

It will be understood that the device according to the invention provides a more versatile device for felling trees, by means of which device the various felling tools can be oriented with even greater precision with respect to the tree. The device according to the invention makes it possible to lop or fell a tree 8 in parts, i.e., branch by branch, rather than in one go, as is done with the prior art device.

Said possibility to fell a tree branch by branch renders the device according to the invention very suitable for use at locations at which it is not possible to fell the tree in one go in connection with the presence of obstacles. Think in this connection of residential areas where the presence of houses, lamp posts, cars, etc., seriously interferes with the maneuverability of the excavator 1 with the boom 2 and a device 3 according to the prior art.

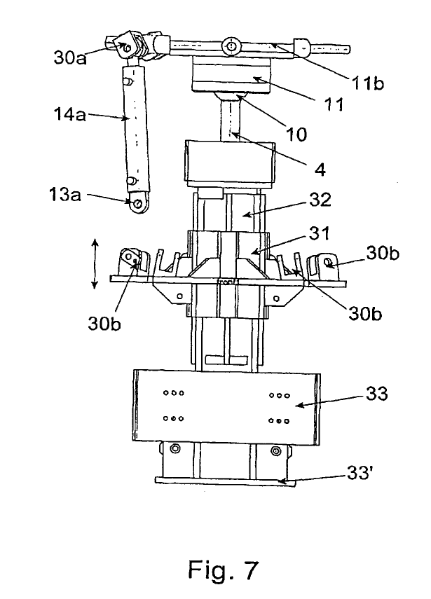

FIG. 7 shows another highly functional embodiment of the device according to the invention. The ball and socket joint 10 on which the supporting plate 11-11b is mounted, to which supporting plate a processing tool (not shown) can in turn be connected, can be adjusted with respect to the boom (not shown) by means of several piston-cylinder combinations 14a-13a. The ball and socket joint 10 and the frame member 4 are of to that end provided with a connecting element 33. which can be connected to, for example, a boom (not shown) by means of a connecting plate 33′.

Several piston-cylinder combinations 13a-14a are provided for adjusting the ball and socket joint 10 and the tool with respect to the boom. The cylinder 14a is connected with its end 13a to the end plate 11b, whilst the piston 13a is connected to the connecting element 30b that is mounted on a guide element 31, which is slidably mounted on an arm 32. It will be understood that several piston-cylinder combinations 13a-14a are used for adjusting the end plate 11b about the ball and socket joint 10 with respect to the arm 32 (and the boom (not shown)), because both the end plate 11b and the guide element 31 are provided with several connecting elements 30a-30b.

The guide element 31 is movable around the arm 32 so as to realize an adequate positioning of the end plate 11b about the ball and socket joint 10-11. This makes it possible to adjust the various piston-cylinder combinations 13a-14a with respect to each other, enabling the guide element 31 to orient itself, so that jamming of the device according to the invention is prevented.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. An operating device for a tool, comprising a frame to be coupled to the boom of an excavator or the like, at least one tool connected to the frame as well as adjusting means for positioning said at least one tool relative to the boom, characterized in that the adjusting means also comprise a ball and socket joint, which pivotally connects said at least one tool to the frame.

2. A device according to claim 1, characterized in that the adjusting means engage the frame on the one hand and said at least one tool on the other hand.

3. A device according to claim 1, characterized in that the adjusting means are hydraulically driven adjusting means.

4. A device according to claim 3, characterized in that the hydraulically adjusting means can be driven by the hydraulic system of the excavator.

5. A device according to claim 1, characterized in that the adjusting means are electromechanically driven adjusting means.

6. A device according to claim 1, characterized in that the adjusting means comprise at least one spindle drive.

7. A device according to claim 6, characterized in that the adjusting means comprise at least three spindle drives.

8. A device according to claim 1, characterized in that the adjusting means comprise at least one piston-cylinder combination.

9. A device according to claim 8, characterized in that the adjusting means comprise at least three piston-cylinder combinations.

10. A device according to claim 1, characterized in that said at least one tool is mounted on a supporting plate that is connected to the ball and socket joint, with the adjusting means engaging the supporting plate.

11. A device according to claim 1, characterized in that the adjusting means engage a guide element that is movable with respect to the frame.

12. A device according to claim 11, characterized in that the ball and socket joint can be connected to the frame by means of an arm, with the guide element being movably provided round the arm.

13. A device according to claim 1, characterized in that the ball and socket joint is connected to the frame by means of a telescopic extension element.

14. A device according to claim 13, characterized in that the ball and socket joint can be accommodated in said telescopic extension element in a shape-locked manner.

15. A device according to claim 13, characterized in that said telescopic extension element is pivotally connected to the frame.
